(19) United States
(12) Patent Application Publication
(10) Pub. No.: US 2013/0238458 A1
(43) Pub. Date: Sep. 12, 2013

(54) RETURNED PRODUCT DATA PROCESSING METHOD, RELATED SYSTEM, AND DEVICE

(71) Applicant: TOSHIBA TEC KABUSHIKI KAISHA, Tokyo (JP)

(72) Inventors: Yasuo ISO, Shizuoka (JP); Taro ANDO, Shizuoka (JP)

(73) Assignee: TOSHIBA TEC KABUSHIKI KAISHA, Tokyo (JP)

(21) Appl. No.: 13/786,426

(22) Filed: Mar. 5, 2013

(30) Foreign Application Priority Data
Mar. 6, 2012 (JP) 2012-049783

(51) Int. Cl. G06Q 20/20

(52) U.S. Cl. CPC G06Q 20/204
USPC 705/23

(57) ABSTRACT

According to one embodiment, the returned product data processing method reads a first code symbol that represents the order code that specifies the order data from a slip, reads a second code symbol that represents a commercial product code that uniquely specifies the commercial product from the slip, generates a returned product code that includes the order code and the commercial product code, and revises the order data that are correlated with the order code based on the returned product data.

### CROSS-REFERENCE TO RELATED APPLICATION

This application is based upon and claims the benefit of priority from Japanese Patent Application No. 2012-049783, filed Mar. 6, 2012; the entire contents of which are incorporated herein by reference.

### FIELD

Embodiments described herein relate generally to a returned product data processing system that process data relating to returned commercial goods.

### BACKGROUND

A web supermarket system is a system for online shopping. With this web supermarket system, an actual supermarket receives orders online, picks up the ordered commercial goods from products at the supermarket, and delivers the goods to the customer. With this system, online shopping sales are processed by a POS (Point of Sales) terminal, in the same way as normal sales at a retail location. Also, the customer can return the purchased product in the same way as with purchases from an actual shop. Using a POS system in the shop, a shop employee checks the receipt and the product, and enters data concerning the returned product into the POS terminal in the shop.

### BRIEF DESCRIPTION OF THE DRAWINGS

FIG. 1 is a system configuration diagram of the web supermarket system according to an embodiment.

FIG. 2 is a hardware block diagram of a web server system according to an embodiment.

FIG. 3 is a hardware block diagram of a shop server according to an embodiment.

FIG. 4 is a layout diagram of a delivery slip according to an embodiment.

FIG. 5 is a layout diagram of a receipt slip according to an embodiment.

FIG. 6 is a hardware block diagram of a headquarters server according to an embodiment.

FIG. 7 is a hardware block diagram of a returned product processing device according to an embodiment.

FIG. 8 is a flowchart for an order process with the web supermarket system according to an embodiment.

FIG. 9 is a sub-flowchart of a printing process according to an embodiment.

FIG. 10 is a flowchart for a returned product process according to an embodiment.

### DETAILED DESCRIPTION

A data processing method for returned products, according to one embodiment, includes reading a first code symbol that includes an order code that specifies order data, reading a second code symbol that includes a commercial product code that uniquely specifies commercial product data, generating returned product data that includes the order code and the commercial product code, and revising the order data that are correlated with the order code, based on the returned product data.

A system for returned products according to additional embodiments includes a first database configured to store plural order data including an order code that uniquely specifies the order data and one or more commercial product codes that are correlated to this order code and uniquely specify the commercial product, a second database configured to store plural commercial product data including the commercial product code, and the commercial product name and unit price that correspond to the commercial product code, and a data processing device for returned products. The data processing device includes a first code reading module configured to read a first code symbol that includes an order code, a second code reading module configured to read a second code symbol that includes a commercial product code, and a generator module configured to generate returned product data that include the order code and the commercial product code.

A data processing device for returned products includes a first code reading module configured to read a first code symbol that includes an order code, a second code read module configured to read a second code symbol that includes a commercial product code, a generator module configured to generate returned product data that include the order code and the commercial product code, and a transmission module that transmits the returned product data to an external device.

Hereinafter, embodiments will be further described with reference to the drawings. In the drawings, the same reference numerals used in different drawings denote the same or similar portions.

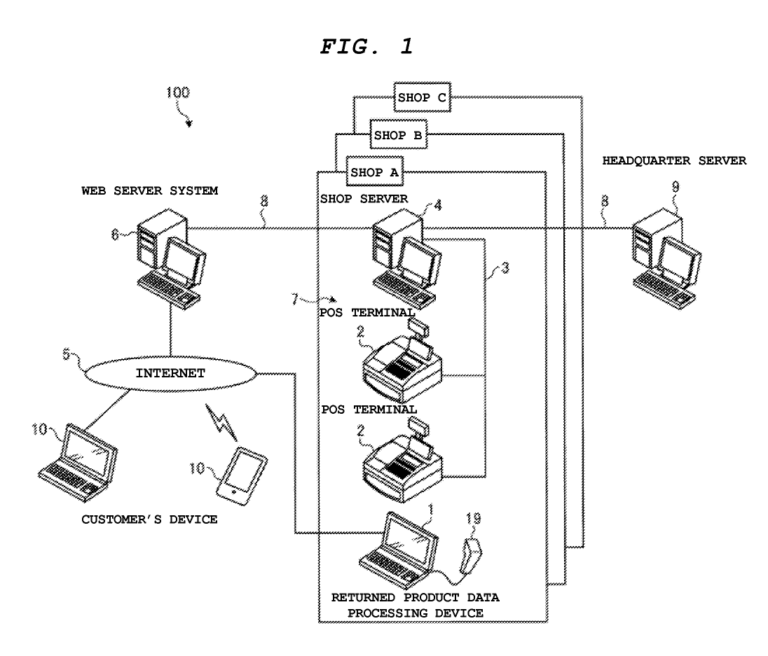

FIG. 1 is a system configuration diagram of a web supermarket system 100 according to the present embodiment. The web supermarket system 100 includes a web server system 6, a shop server 4, a POS terminal 2, a returned product processing device 1, and a headquarters server 9. The web server system 6 provides the web supermarket service to the customer via the Internet. The shop server 4 is installed in retail locations (for example shops a-c) that handle the delivery of the commercial product that is ordered by the customer. The POS terminal 2 executes an account processing in the shop. The returned product processing device 1 receives information on the product that is returned by the customer. This returned product processing device 1 includes a scanner 19. The headquarters server 9 is connected to the plural shop servers 4 under its jurisdiction and carries out the management of sales data, inventory, etc.

The web server system 6 carries out data communication with a customer's device 10 via the Internet 5. A member uses the customer's device 10 and accesses a website that is provided by the web server system 6 and selects a desired commercial product. The selected commercial product is ordered by the customer. The web server system 6 generates order data based on this order. The web server system 6, the shop server 4, and the headquarters server 9 are connected to each other by a dedicated line 8. The web server system 6 transmits order data to the shop server 4. The shop server 4 outputs various slips based on the order data. Based on these slips, the commercial products are delivered to the address of the member. The shop server 4 or the POS terminal 2 registers the sales data, for the products that have been delivered, to the shop sales data file. The headquarters server 9 receives sales data from each shop server 4 and carries out the management of sales.

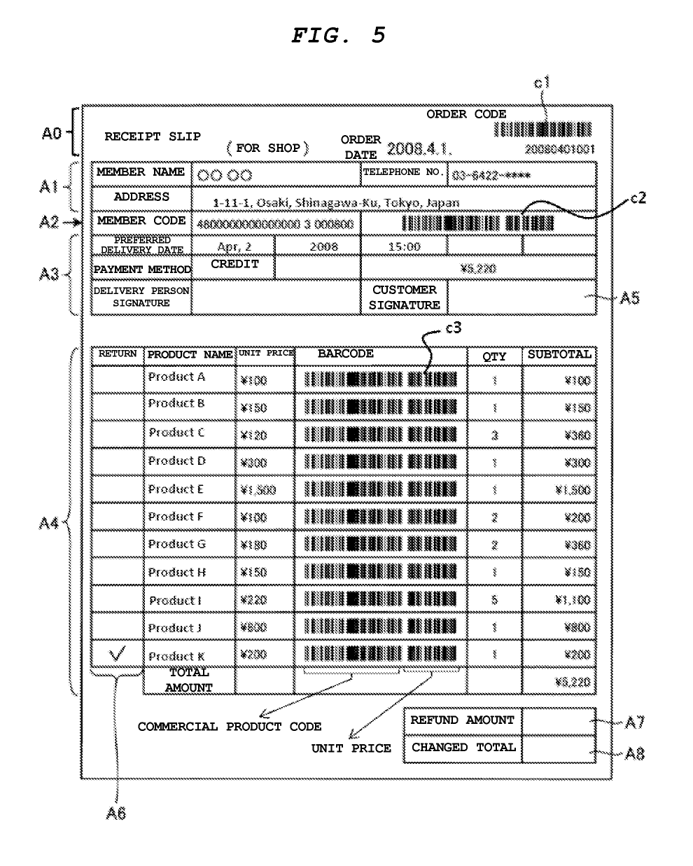

The returned product processing device 1 generates returned product data concerning commercial products that have been returned based on a receipt slip described below with reference to FIG. 5, and transmits the data to the web server system 6. The web server system 6 transmits the received returned product data to the shop server 4. The shop server 4 generates the final sales data based on the returned product data and order data, and transmits the final sales data to the headquarters server 9. The headquarters server 9 updates the chain sales file based on the sales data that are transmitted from different shops.

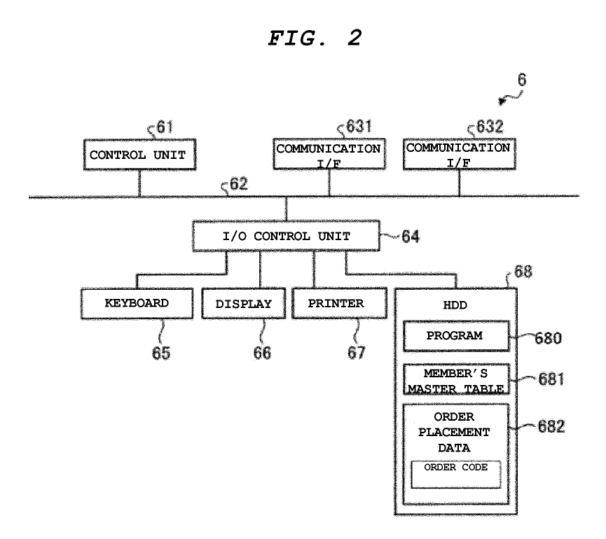

FIG. 2 is a hardware block diagram of the web server system 6. The web server system 6 includes a control unit 61 including a CPU, ROM, and RAM. Additionally, the control unit 61 is connected to a keyboard 65, a display 66, a printer 67, and an HDD (Hard Disk Drive) 68, via a bus 62 and an I/O (input/output) control unit 64. The control unit 61 carries out data communications with the shop servers 4 via a communication I/F (interface) 631 and the dedicated line 8. The control unit 61 carries out data communication with the customer's device 10 or the returned product processing device 1 via communications I/F 632 and the Internet 5.

The HDD 68 stores a program 680, a member's master table 681, and an order data DB 682. The program 680 makes the web server system 6 function as an order receipt system of the web supermarket system 100. The member's master table 681 stores member information. This member information includes a member code, first and last names, address, phone number, E-mail address, earned points, and the jurisdictional shop information, etc. The member code is a unique number to specify a member. The jurisdictional shop is the closest shop that is specified by the address of the member.

The order data DB 682 stores order data that are generated by the control unit 61. The order data include an order code, a member code, a selected commercial product code, a unit price and the quantity of the selected commercial product, the total amount, the preferred delivery date, and the payment method. The order code is a code to uniquely identify the transaction that has been placed on order. The commercial product code is a code to uniquely identify the commercial product.

The control unit 61 acquires product information such as the commercial product name and unit price, etc., from the shop server 4. Based on the product information, the control unit 61 generates a web image for ordering and shows the web image on the website on the Internet. On the website, the web server system 6 requests an input of the member number and password to authenticate the member. The control unit 61 identifies the member that carries out the placement of the order with this member authentication.

When an order for a commercial product is transmitted from the customer's device 10, the control unit 61 collects various information regarding this order and generates the order data. The control unit 61 stores this order data in the order data DB 682. The control unit 61 transmits the generated order data to the shop server 4.

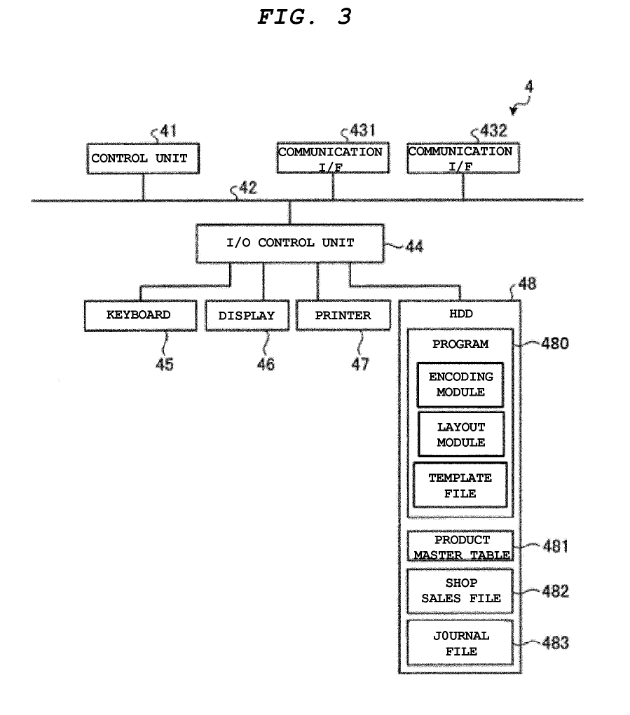

FIG. 3 is a hardware block diagram of the shop server 4. The shop server 4 is controlled by a control unit 41 that includes a CPU, ROM, and RAM, etc. The control unit 41 is connected to a keyboard 45, a display 46, a printer 47, and an HDD 48, via a bus 42 and an I/O control unit 44.

The control unit 41 carries out data communications with the headquarters server 9 or the web server system 6 via a communication interface 432 and the dedicated line 8. Additionally, the control unit 41 carries out data communications with plural POS terminals 2 via a communication interface 431 and a LAN 3. The POS terminal 2 transmits sales data of a real shop to the shop server 4.

The HDD 48 stores a program 480, a commercial product master 481, a retail location sales file 482, and a journal file 483. The commercial product master 481 is a file that stores product information such as the commercial product name and unit price, etc., in association with the commercial product code. The retail location sales file 482 is a file that stores sales data in a shop. In a transaction at a real shop, the sales data that are transmitted from the POS terminal 2 are registered in the retail location sales file 482. In the example shown in FIG. 1, real shops include Shop a, Shop b, and Shop c. In a transaction within the web supermarket system, sales data based on the order data that are transmitted by the web server system 6 are registered in the retail location sales file 482.

The journal file 483 stores log data that record the transaction history of the POS terminal 2 and the web server system 6. The log data is called an electronic journal and is the source data of all transactions. The electronic journal on the web server system 6 is generated by the control unit 41 based on the order data that are transmitted from the web server system 6. It may be also possible for the control unit 61 of the web server system 6 to generate an electronic journal on the web server system 6.

The program 480 includes plural modules to update the retail location sales file 482 and the journal file 483, an encoding module, and a layout module. The encoding module and the layout module generate the print data for the slips that are printed by the printer. The encoding module converts the member code, the commercial product code, and the unit price to a one-dimensional or two-dimensional barcode. The layout module embeds the order data and the barcode to the template file of the slip. The slip that is generated by the layout module is outputted by the printer 47.

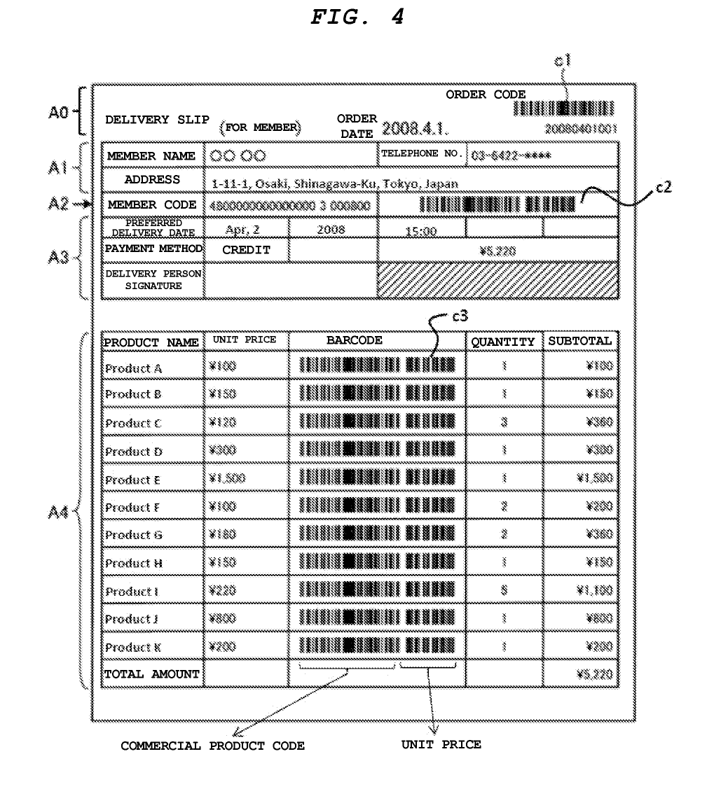

The control unit 41 prints a delivery slip (refer to FIG. 4) and a receipt slip (refer to FIG. 5) by the printer 47 based on the order data that are transmitted by the web server system 6. At the shop, a shop employee packs the commercial product according to the commercial product name and the quantity as recorded in these slips. The delivery person delivers the packaged commercial product to the customer's home at the shipping address.

FIG. 4 is a layout diagram of the delivery slip. The delivery slip is handed to the customer along with the commercial product. The delivery slip includes five areas (A0, A1, A2, A3, and A4). In area A0 of the template file, the order date, the order code, and the order barcode C1 are embedded by the layout module. The order barcode C1 is the order code that is converted to a barcode by the encoding module. In area A1, the member information is embedded by the layout module. In area A2, the member code and earned points data are embedded by the layout module. Additionally, the member code and the earned points data are converted to an earned point barcode C2 by the encoding module. This earned point barcode C2 is embedded in the area A2 by the layout module.

In area A3, the preferred delivery date, the method of payment, and the payment amount are embedded by the layout module. In area A4, the detailed data of the commercial product that the member ordered are embedded by the layout module. The detailed data include the commercial product name, the unit price, the product information barcode C3, the quantity, and the subtotal. The data that combine the commercial product code and the unit price are converted to a barcode by the encoding module. This barcode is embedded in area A4 of the template file by the layout module. The commercial product information code can be a barcode that combines three pieces of data, the commercial product code, the unit price, and the quantity.

In the present embodiment, the member code and the commercial product information code are an 18-digit one-dimensional barcode including a 13-digit code and a 5-digit code. In place of this one-dimensional barcode, a two-dimensional barcode or a code symbol in another form may be used.

FIG. 5 is a layout diagram of the receipt slip. The receipt slip has a signature field that is entered by the member. This receipt slip is archived at the shop after it is signed by the member. In contrast with the delivery slip, four areas (A5, A6, A7, and A8) are further included in the template of the receipt slip. Area A5 is a signature field for the member. Area A6 is a check field for returned products. In the case where the member desires to return a commercial product, the delivery person enters a check mark in area A6. Area A7 is an entry field for the refund amount. Area A8 is an entry field for changed payment. The delivery person may enter each amount in areas A7 and A8.

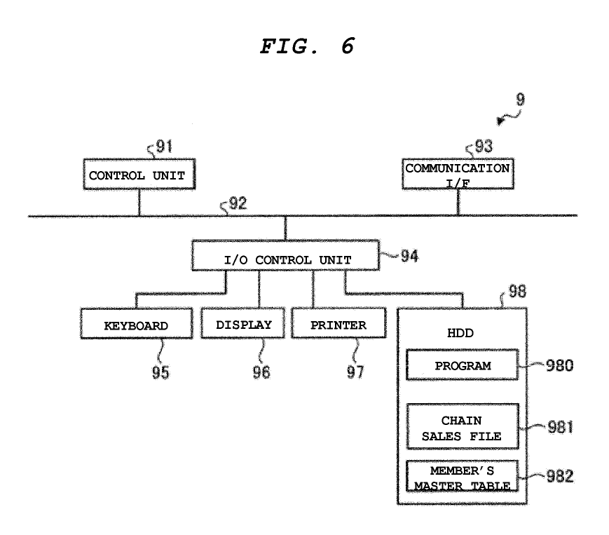

FIG. 6 is a hardware block diagram of the headquarters server 9. The headquarters server 9 includes a control unit 91 that includes a CPU, ROM, and RAM, etc. Additionally, a keyboard 95, a display 96, a printer 97, and an HDD 98 are connected to the control unit 91 via a bus 92 and an I/O control unit 94. The control unit 91 carries out data communication with the shop servers 4 via communications I/F 93 and a dedicated line 8.

The HDD 98 stores a control program 980, a chain sales file 981, and a member master 982, etc. The control program 980 controls the entire headquarters server 9. The chain sales file 981 stores the sales data that are transmitted from the shop server 4 of each shop. The member's master table 982 is the same configuration as the member's master table 681 of the web server system 6. These two member's master tables may be mutually synchronized.

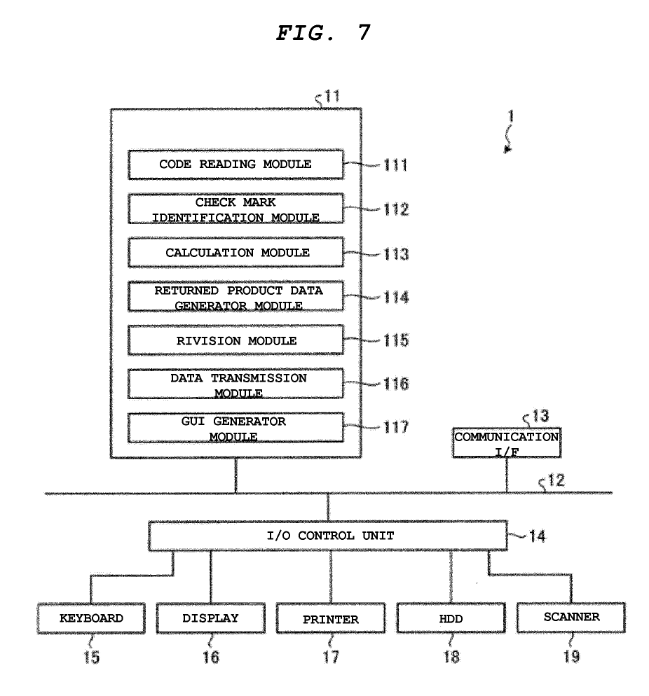

FIG. 7 is a hardware block diagram of the returned product processing device 1. The returned product processing device 1 is controlled by a control unit 11 that includes a CPU, ROM, and RAM, etc. A keyboard 15, a display 16, a printer 17, an HDD 18 and the scanner 19 are connected to the control unit 11 via a bus 12 and an I/O control unit 14. The control unit 11 carries out data communication with the web server system 6 via communications I/F 13 and an internet 5.

According to a program expanded in the RAM, the control unit 11 functions as a code reading module 111, a check mark identification module 112, a calculator module 113, a returned product data generator module 114, a revision module 115, a data transmission module 116, and a GUI (Graphical User Interface) generator module 117.

The code reading module 111 decodes the barcode data that are read by the scanner 19 and reads out information. The code reading module 111 reads out the order code, the member code, the earned points, the commercial product code, and the unit price from each barcode.

The check mark identification module 112 judges whether or not a check mark is entered in area A6 of the receipt slip with the scanner 19. In the case where the scanner 19 having a CCD sensor installed therein is connected to the returned product processing device 1, this check mark identification module 112 executes the process. In the case where a laser-type scanner 19 is connected to the returned product processing device 1, this check mark identification module 112 may stop functioning.

The calculating module 113 adds the unit price of the commercial product that is being returned. In the case where the code reading module 111 reads the commercial product information barcode C3, the calculating module 113 extracts at least the unit price information and calculates the refund amount. In the case where the unit price information is not included in the commercial product information barcode C3, the calculating module 113 may extract the unit price that is correlated with the corresponding commercial product code from the order data.

The returned product data generator module 114 generates the returned product data based on the order code, the commercial product code, the unit price, and the refund amount. The returned product data generator module 114 could also use the quantity information that corresponds to the commercial product code. The order code, the commercial product code, and the unit price may be acquired from the code reading module 111. The refund amount may be acquired from the calculating module 113.

The revision module 115 revises the order data based on the returned product data that are generated by the returned product data generator module 114. The data transmission module 116 transmits the revised order data and the returned product data to the web server system 6 via the communication I/F 13 and the Internet 5. The data transmission module 116 can also directly transmit these data to the shop server 4 and the headquarters server 6.

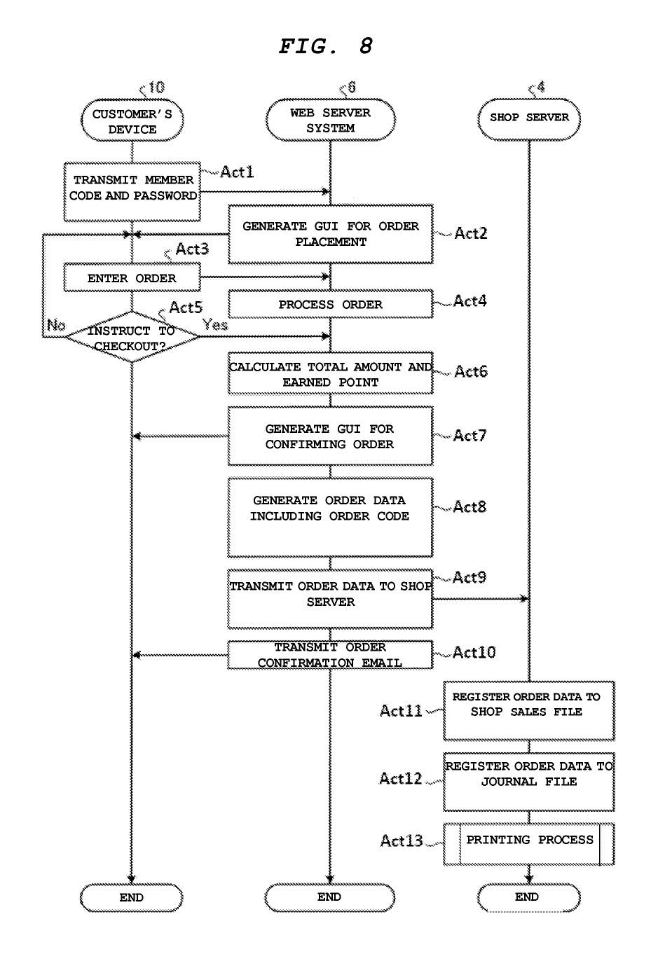

FIG. 8 is a flowchart for the order process in the web supermarket system 100.

The customer's device 10 accesses the web server system 6 and transmits the member code and password to the web server system 6 (Act 1). The web server system 6 executes member authentication based on the received member code and password. When member authentication is done, the control unit 61 of the web server system 6, acquires member information from the member's master table 681 based on the received member code. The control unit 61 generates a GUI for order placement, including member information, and transmits this GUI to the customer's device (Act 2).

The member then selects the desired commercial product on the GUI for order placement. Every time a member selects a commercial product, the customer's device 10 transmits the selected commercial product code to the web server system 6 (Act 3). The control unit 61 acquires commercial product information from the commercial product master table 481 based on the received commercial product code, and writes this commercial product information into a temporary file (Act 4). Next, the customer's device determines if it has received an instruction through the GUI to checkout, e.g., when the selection of the commercial product is done (Act 5). If yes, the web server system 6 calculates the total amount and the earned points from the commercial product information that is stored in the temporary file (Act 6). Earned points may be calculated based on a set rule. For example, 1% of the total amount is given to the member as points.

The control unit 61 generates GUI for confirming the order based on the member information, the commercial product information in the temporary file, the total amount, and earned points (Act 7). The member enters the method of payment and preferred delivery date on this GUI. For example, payment methods include credit card, debit card, and cash. When the member finishes confirming the order content, the control unit 61 generates an order code to specify the order that is placed (Act 8). The control unit 61 generates order data including the order code, the member information, the information on the selected commercial product, the total amount, the payment method, and the preferred delivery date (Act 8). This order data are registered in the order data DB 682 (Act 8). The control unit 61 transmits this order information to the shop sever 4 (Act 9). The control unit 61 transmits an E-mail including the order data to the member based on the order data (Act 10).

The control unit 41 of the shop server 4 registers the order data received from the web server system 6 to the retail location sales file 482 and the journal file 483 (Act 11, 12). The control unit 41 executes the printing process based on the order data. The printer 47 prints the delivery slip and the receipt slip (Act 13).

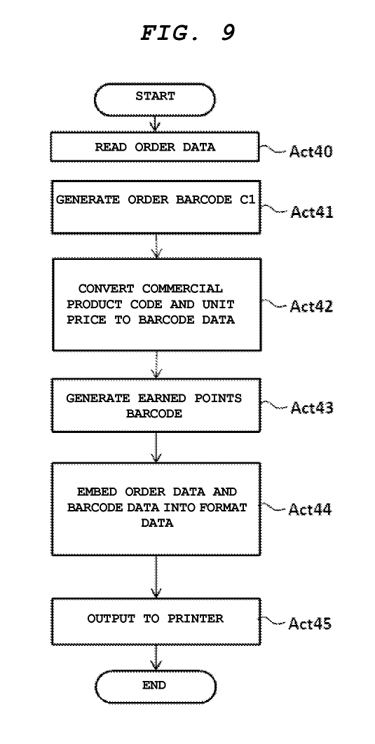

FIG. 9 is a sub-flowchart of the printing process. The control unit 41 of the shop server 4 acquires the order data that is received from the web server system 6 (Act 40). The encoding module extracts the order code from the order data, and generates an order barcode C1 (Act 41). The encoding module extracts the commercial product code and the unit price from the order code, and generates a commercial product information barcode C3 for each commercial product code (Act 42). The encoding module extracts the member code and earned points from the order data and generates an earned point barcode C2 (Act 43). The layout module embeds the order data, the order barcode C1, the earned point barcode C2, and the commercial product information barcode C3 into areas A0-A4 of the template file in the delivery slip and the receipt slip (Act 44). The template file with embedded information is printed out by the printer 47 (Act 45).

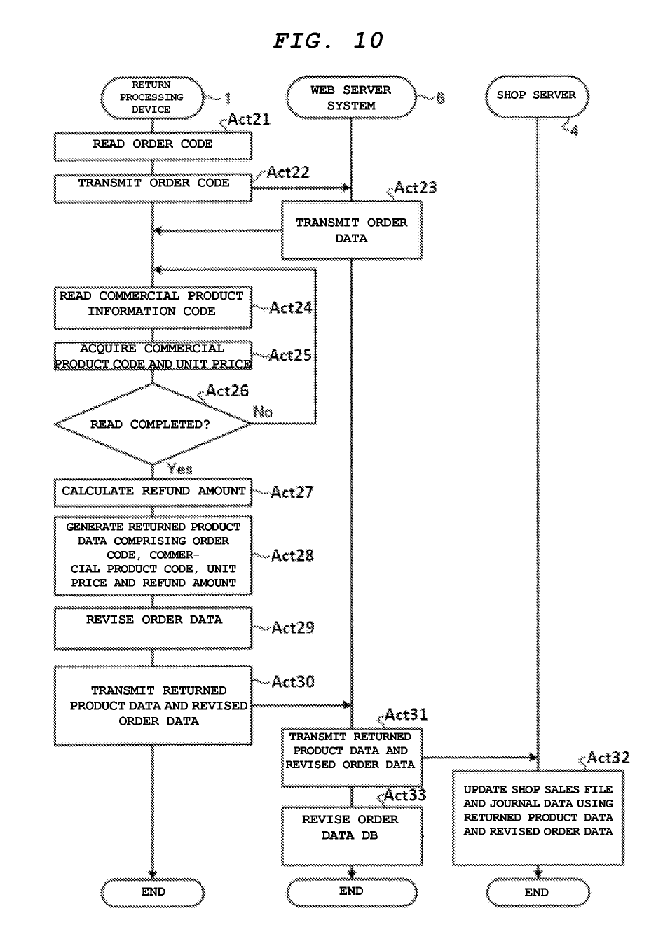

FIG. 10 is a flowchart for the returned product process. When the product return process is selected from the GUI generated by the GUI generator module 117, the order barcode C1 of the receipt slip is scanned by the scanner 19 (Act 21). The code reading module 111 decodes the order code from the order barcode C1. The returned product processing device 1 transmits the order code to the web server system 6 (Act 22). The web server system 6 extracts the order data from the order data DB 682 based on the received order code. The extracted order data are transmitted to the returned product processing device 1 (Act 23). This order data are recorded in a temporary file in the returned product processing device 1.

The check mark identification module 112 checks whether or not a check mark is entered in area A6. The commercial product information barcode C3 of the commercial product with a check mark entered in area A6 is acquired by the scanner 19 (Act 24). The code reading module 111 decodes the commercial product code and the unit price from this commercial product information code C3 (Act 25). The commercial product code and unit price are recorded in a temporary file. Acts 24 and 25 are continued until all of the commercial product information codes C3 with a check mark entered in area A6 are read (Act 26).

The calculating module 113 adds the unit price recorded in the temporary file and calculates the refund amount (Act 27). The GUI generator module generates the GUI to confirm the returned product content. The returned product data generator module 114 generates returned product data from the order code, the commercial product code, the unit price, and the refund amount, etc. (Act 28). The revision module 115 revises the order data in the temporary file based on the returned product data (Act 29). The data transmission module 116 transmits the returned product data and the revised order data to the web server system 6 (Act 30).

The web server system 6 transmits the returned product data and the revised order data to the shop server 4 (Act 31). The web server system 6 revises the order data DB 682 based on the returned product data and/or the revised order data (Act 33). The shop server 4 revises the retail location sales file 482 and the journal file 483 based on the returned product data and/or the revised order data (Act 32).

The revision module 115 may executed on the web server system 6 or the shop server 4, and so the revision of the order data can be executed by the web server system 6 or the shop server 4. It is possible to install each module described in the present embodiment in all the devices in the web supermarket system 100.

The storage location for the database is not limited to the present embodiment. The database of the present embodiment can be stored in all the devices in the web supermarket system 100.

A scanner is connected to the POS terminal 2 that is used in a shop. Therefore, it is also possible for the POS terminal 2 to have the function of the returned product processing device 1.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A data processing method for returned products, comprising:
reading a first code symbol that includes an order code that specifies an order data;
reading a second code symbol that includes a commercial product code that uniquely specifies a commercial product;
generating returned product data that includes the order code and the commercial product code; and
revising the order data that are correlated with the order code, based on the generated returned product data.

2. The data processing method according to claim 1, wherein
the second code symbol further includes unit price information of the commercial product that is specified by the commercial product code.

3. The data processing method according to claim 1, wherein the first and second code symbols are read from a printed document.

4. The data processing method according to claim 3, wherein
the printed document includes a list of purchased items, and
each row of the list includes a commercial product name, a second code symbol, a unit price, and a field where a mark to indicate a return, is to be entered.

5. The data processing method according to claim 4, further comprising:
determining the presence/absence of the mark, and
reading out the commercial product code from the second code symbol in a row where the mark has been entered.

6. The data processing method according to claim 5, wherein the returned product data are generated using the order code and the commercial product code from each row where the mark has been entered.

7. The data processing method according to claim 3, further comprising:
generating the order code correlated with the order data;
generating the first code symbol from the order code;
generating the second code symbol that includes a commercial product code and the unit price information;
embedding the first code symbol and the second code symbol into a template file; and
printing the template file as the printed document.

8. A returned product data processing system, comprising:
a first database configured to store a plurality of order data including an order code that uniquely specifies order data and one or more commercial product codes that are correlated with the order code and uniquely specify commercial products;
a second database configured to store a plurality of commercial product data including the commercial product code, a commercial product name and a unit price that correspond to the commercial product code; and
a returned product data processing device, the device comprising:
a first code reading module configured to read a first code symbol that includes an order code that specifies an order data,
a second code reading module configured to read a second code symbol that includes the commercial product code, and
a generator module configured to generate returned product data that includes the order code and the commercial product code.

9. The returned product data processing system according to claim 8, wherein
the second code symbol further includes unit price information for the commercial product that is specified by the commercial product code.

10. The data processing method according to claim 8, wherein the first and second code reading modules are configured to read the first and second code symbols, respectively, from a printed document.

11. The returned product data processing system according to claim 10, wherein
the printed document includes a list of purchased items, and
each row of the list include a commercial product name, a second code symbol, a unit price, and a field where a mark to indicate a return, is to be entered.

12. The returned product data processing system according to claim 11, further comprising:
a mark determining module configured to determine the presence/absence of the mark,
wherein the second code reading module reads out the commercial product code from the second code symbol of the commercial product in a row where the mark has been entered.

13. The data processing method according to claim 12, wherein the generator module generates the returned product data using the order code and the commercial product code from each row where the mark has been entered.

14. The returned product data processing system according to claim 10, further comprising:
an order code generating module configured to generate the order code correlated with the order data;
a first encoding module configured to generate a first code symbol from the order code;
a second encoding module configured to generate a second code symbol that includes the commercial product code and the price, from the order data;
a layout module configured to embed the first code symbol and the second code symbol into a template file of the slip; and
a printer that prints the slip.
generating the order code correlated with the order data;
generating the first code symbol from the order code;
generating the second code symbol that includes a commercial product code and the unit price information;
embedding the first code symbol and the second code symbol into a template file; and
printing the template file as the printed document.

15. The returned product data processing system according to claim 8, further comprising:
a revision module configured to revise the order data that are correlated with the order code and stored in the first database, based on the returned product data.

16. A returned product data processing device, comprising:
a first code reading module configured to read a first code symbol that includes an order code;
a second code reading module configured to read a second code symbol that includes a commercial product code;
a generator module configured to generate returned product data that include the order code and the commercial product code; and
a transmission module configured to transmit the returned product data to an external device.

17. The returned product data processing device according to claim 16, wherein
the second code symbol further includes a unit price information of the commercial product that is specified by the commercial product code.

18. The returned product data processing device according to claim 16, wherein the first and second code reading modules are configured to read the first and second code symbols, respectively, from a printed document.

19. The returned product data processing device according to claim 18, wherein
the printed document includes a list of purchased items, and
each row of the list includes a commercial product name, a second code symbol, a unit price, and a field where a mark to indicate a return, is to be entered.

20. The returned product data processing device according to claim 19, further comprising:
a mark determining module configured to determine the presence/absence of the mark,
wherein the second code reading module reads out the commercial product code from the second code symbol of the commercial product in a row where the mark has been entered.
